(19) United States
(12) Patent Application Publication
(10) Pub. No.: US 2012/0050852 A1
(43) Pub. Date: Mar. 1, 2012

(54) Transmitted light fluorescence microscope and kit for adapting a microscope to the transmitted light fluorescence working mode

(76) Inventors: Marco Angelini, Bereguardo (IT); Natale Aldo, Dugnano (IT); Claudia Bigliati, Trino (IT); Luca Scodes, San't Angelo Lodigiano (IT)

(21) Appl. No.: 11/794,844

(22) PCT Filed: Jan. 5, 2006
(86) PCT No.: PCT/IB2006/000160

§ 371 Date: May 4, 2011

(30) Foreign Application Priority Data
Jan. 7, 2005 (IT) MI2005A000019

(51) Int. Cl. G02B 21/08

(52) U.S. Cl. 359/385

(57) ABSTRACT

A transmitted light fluorescence microscope, presents a mount, a lighting assembly and a condenser interposed between the lighting assembly and the mount; the lighting assembly includes at least one LED which emits in a spectral band adapted to excite the fluorescence of the sample to be analyzed and is arranged below the mount to light the sample from underneath; an emission filter is interposed between the sample-holder mount and an eyepiece of the microscope for filtering the fluorescent emission of the sample.

### TECHNICAL FIELD

The present invention relates to a transmitted light fluorescence microscope and to a kit for adapting a microscope to the transmitted light fluorescence working mode.

### BACKGROUND ART

It is known that fluorescence microscopy (consisting in exciting, by means of a light beam of predetermined spectral band, a sample, either self-fluorescent or incorporating a fluorophore, and detecting the fluorescent emission of the sample) calls for a very intense illumination of a small portion of the sample, where a high radiance must be obtained; therefore, the known fluorescence microscopes employ high-efficiency light sources, typically short-arc discharge or halogen lamps.

In order to avoid the drawbacks related to the use of this type of sources (in particular, high cost and energy consumption; short life; bulky size; very wide emission bands with consequent need to use heavy filters; risks of deterioration of the samples and not very satisfactory lighting efficiency), International Patent Application WO 2004/088387 envisages the use of a lighting assembly having a plurality of integrated LED modules; the lighting assembly is arranged, as however in most fluorescence microscopes with traditional sources, either behind or by the side and over the sample-holder mount, so as to send the light from the top onto the sample (so-called “epi-illumination” mode, in which the emission of the sample is observed from the same side as which the excitation light is sent onto the sample).

With the currently available LEDs, however, the illumination intensity obtainable on the sample with this configuration may not be fully satisfactory. Furthermore, since the excitation light reaches the sample through the microscope objective, the illumination field intensity depends on the type of objective used: while the intensity may be sufficient for objectives with magnification of approximately 40× and higher, at lower magnifications (which are often used for fluorescence analysis) intensity is clearly insufficient.

On the other hand, traditional microscopes, called “bright field” or “white light”, in which a traditional light source (typically a halogen lamp) it is arranged underneath the sample and used in association with an Abbe condenser for direct white light observation are known. These microscopes, in their original configuration, cannot be used alternatively for white light direct observation and for fluorescence analysis. Indeed, the traditional sources and in particular the halogen lamps have continuous emission spectrums: narrow band filters are therefore needed for fluorescence analysis with consequent drastic reduction of the available radiating power; thus, for the same reason, since a high signal/noise ratio is required for fluorescence, the excitation filter to be used also is very heavy with consequent further reduction of the available radiating power. Furthermore, fluorescence analysis requires a much more concentrated beam that white light observation; because the size of the halogen lamps filament is considerable, these lamps are not suitable to concentrate the excitation light in a narrow high radiation density zone. For the same reason, the Abbe condenser normally used in “white light” microscopes cannot be used for fluorescence analysis because, given its optical features, it does not sufficiently concentrate the beam of light. Furthermore, the optical components forming such condenser may also be fluorescent and therefore noticeably worsen the signal/noise ratio during observation. Therefore, also such condenser should be modified or better replaced with one dedicated to switch from one working mode to the other. With “white light” microscopes in their original configuration, switching to the fluorescence working mode is therefore practically impossible.

Furthermore, since transmitted light fluorescence analysis generally gives rise to a very high background noise and therefore to a very low signal/background ratio, it is commonly held, by whose skilled in the art, that transmitted light fluorescence analysis is not very efficient and/or requires the use of heavy filters.

### DISCLOSURE OF INVENTION

It is an object of the present invention to provide a fluorescence microscope designed to eliminate the aforementioned drawbacks of the known art.

In particular, it is an object of the invention to provide a fluorescence microscope which is simple and cost-effective to manufacture, compact, low-cost, practical to use and has low consumption; it is a further object of the invention to provide a particularly versatile fluorescence microscope, which is simply and effectively capable of alternatively different working modes (particularly, direct white light observation and fluorescence analysis).

In accordance with such objects, the present invention relates to a transmitted light fluorescence microscope and to a kit for adapting a microscope to the transmitted light fluorescence working mode as defined in the accompanying claims 1 and 16, respectively.

The microscope according to the invention is simple and cost-effective to manufacture, compact, low-cost, practical to use and has low consumption; the microscope of the invention is also extremely versatile, because it can alternatively operate according to different working modes (in particular, direct white light observation and fluorescence analysis), always efficiently and without requiring interventions or complicated or demanding adjustments.

### BRIEF DESCRIPTION OF THE DRAWINGS

Further features and advantages of the present in invention will be apparent in the description of the following non-limiting examples, with reference to the accompanying drawings, in which:

FIG. 1 is a schematic, simplified and partially sectioned view of a first embodiment of a microscope according to the invention;

FIG. 2 shows a detail on magnified scale of the microscope in FIG. 1;

FIGS. 3 and 4 are schematic views of a condenser belonging to the microscope in FIG. 1, shown in respective modes of use;

FIG. 5 is a perspective view of a second embodiment of the microscope according to the invention, comprising a traditional microscope and a fluorescence working mode adaptation kit;

FIG. 6 is an exploded partial view of the adaptation kit in FIG. 5;

FIG. 7 is a schematic view of a detail of the microscope in FIG. 5.

### BEST MODE FOR CARRYING OUT THE INVENTION

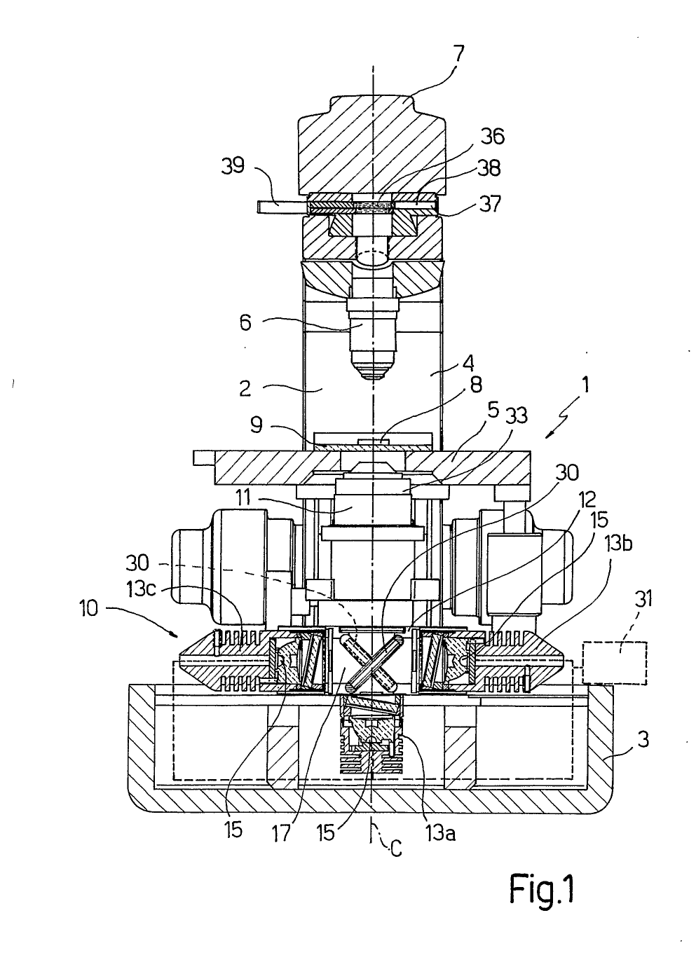

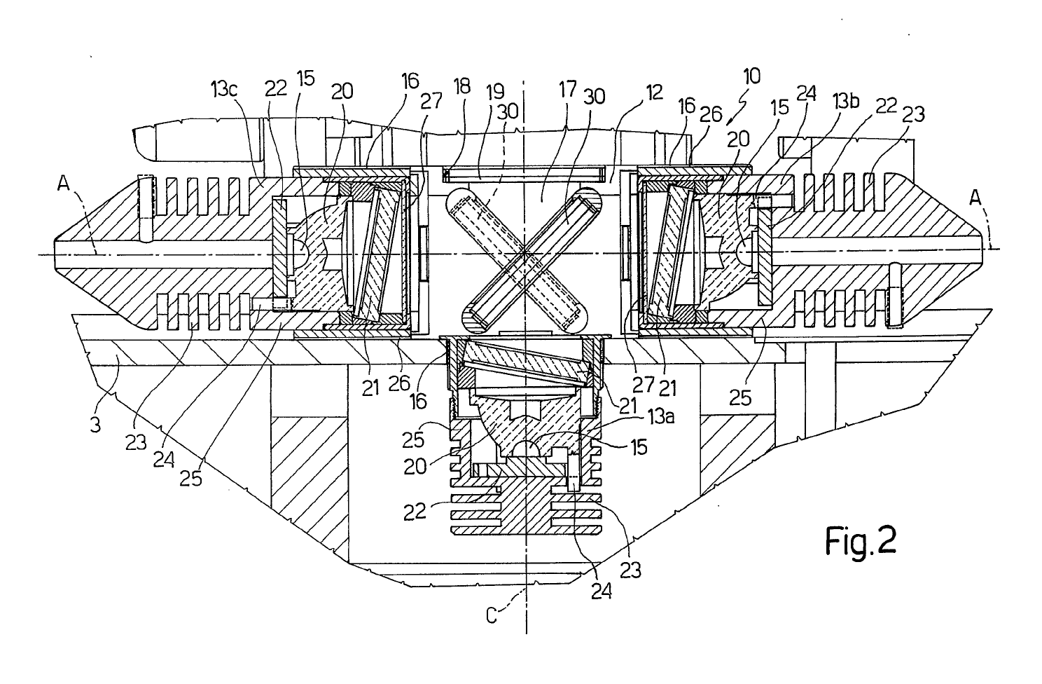

With reference to FIGS. 1 and 2, a transmitted light fluorescence microscope 1 comprises a base structure 2, essentially known and having in particular an internally hollow base 3 from which vertically extend a column 4, a sample-holder mount 5, one or more objectives 6, and an eyepiece 7 (all known components and neither described nor illustrated in detail for the sake of simplicity). The sample 8 to be analysed is carried for example by a transparent slide 9 placed on the mount 5.

The microscope 1 also comprises a lighting assembly 10, arranged underneath the mount 5, and a condenser 11, arranged between the lighting assembly 10 and the mount 5.

The lighting assembly 10 comprises a box 12 and a plurality of integrated lighting modules 13, which are supported by the box 12 and are provided with respective LEDs 15 (or other similar solid state light sources); the LEDs 15 present respective emission bands different one from the other and are arranged underneath the mount 5 to illuminate from underneath the sample 8 to be analysed on the mount 5; at least one LED 15 emits a spectral band adapted to excite the fluorescence of the sample.

Box 12 is releasably coupled, in a known way not shown for the sake of simplicity, to the base 3, so that the lighting assembly 10 is completely removable from the base 3; the box 12 presents a plurality of seats 16 for respective modules 13; the modules 13 face a chamber 17 inside the box 12 presenting an exit window 18 which is arranged in use in front of the condenser 11 and is closed by a transparent plate 19.

In the non-limiting example shown in FIGS. 1 and 2, the lighting assembly 10 comprises three modules 13 essentially arranged in a T; a central module 13a is aligned with the condenser 11 essentially along an optical axis C of the condenser 11, and two side modules 13b, 13c are arranged and facing each over and on opposite sides of the central module 13a.

Each module 13 comprises a casing 25, inside which are accommodated a LED 15, a collimator 20 and a filter 21 arranged aligned along an optical axis A of the collimator 20; the LED 15 is carried by a plate 22 fastened to a thermal dissipator 23; the collimator 20 is arranged in close proximity to the LED 15 and is overhangingly supported by stems 24 from the plate 22; the filter 21 is an inferential filter, chosen according to the emission band of the LED 15 with which it is associated. The casing 25 is provided with releasable fastening means 26 to a seat 16 and is frontally closed, in front of the filter 21, by a clear plate 27; the means 26 may be of any known type, for example bayonet-joint means, threaded means or snap means, and have the function of allowing the complete removal of the module 13 from the box 12 and its replacement with another similar module having a LED with a different emission band.

The collimator 20 is a complex-surface catadioptric collimator and, preferably, a total-internal-reflection surface collimator and is shaped so as to collect the emission of the LED 15 to which it is associated and convey it into a beam of essentially parallel light rays.

The filter 21 is arranged in front of the collimator 20 on the opposite side of the LED 15 to select a band to send onto the sample to be analysed. The filter 21 is essentially disc-shaped and slanted with respect to the optical axis A of the collimator 20, preferably at an angle from approximately 10° to approximately 15°. The slant of the filter 21 avoids the formation of so-called ghost images created by the reflection of the sample emission on the (generally highly reflecting) surfaces of the filter.

The chamber 17 also presents a side opening 28 and a pair of guides 29 arranged in a cross and the lighting assembly 10 also comprises one or more foils 30 carried by sliders 31 sliding on the guides 29; each foil 30 is removably accommodated in the chamber 17 and interposed between the modules 13 and the condenser 11 and is interchangeable with another different foil. The foils 30 can therefore be extracted from the side of the chamber 17 to be replaced with different foils, according to the module (and therefore of the LED 15) used. The foils 30 are in particular reflecting, dichroic or mirror foils according to needs.

The lighting assembly 10 then comprises an electronic control unit 32 (known and only schematically indicated with a dotted line in FIG. 1, along with the connections to the modules 13) for the management of the LEDs 15, which controls the selective lighting of the LEDs 15 and optionally regulates the emission intensity of the LEDs 15.

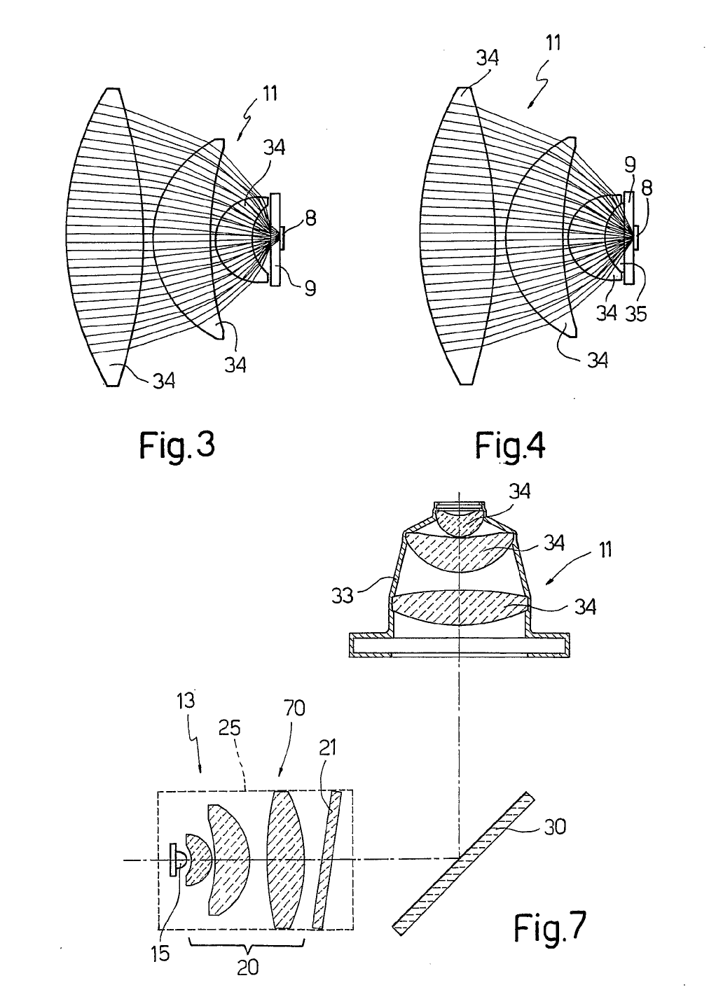

The condenser 11 is an Abbe condenser having a casing 33 which accommodates two or more lenses: for example, as shown in FIGS. 3 and 4, three lenses 34. In all cases, the condenser 11 has a focal distance less than approximately 20 mm and preferably less than approximately 15 mm, and numeric aperture higher than approximately 0.8 and preferably higher than approximately 0.9 (as known, the numeric aperture NA of a condenser is the quantity which characterises the maximum light collection angle, measured with respect to the optical axis and defined as NA=n sen α, where n is the refraction index of the means found at the condenser outlet and α is the maximum output angle of the beam measured with respect to the optical axis).

The focal distance and numeric aperture values are understood as “dry”, that it with the condenser 11 working in air.

The condenser 11 is prepared for use, without the need for changes or adjustments, according to both typical fluorescence microscopy working modes (shown in FIGS. 3 and 4):

“dry” mode, that is when the means between the condenser outlet 11 and the slide 9 on which the sample 8 is arranged is air (FIG. 3), and

“immersion” mode, that is when a liquid 35 is used, typically oil, between the condenser outlet 11 and the slide 9 (FIG. 4).

With the help of an optional field diaphragm (known and not shown), the condenser 11 allows also to obtain an lighting system according to the Köhler diagram.

The microscope 1 also comprises a filter assembly 36 have at least one emission filter 37 (FIG. 1) arranged before the eyepiece 7 to filter the fluorescent emission of the sample before it reaches the eyepiece 7 (or another known detection device capable of collecting the emission of the sample). The emission filter 37 is selected according to the emission of the LED 15 used; the emission filter 37 is therefore extractable from a seat 38 formed in the column 4 and interchangeable with another filter, or selectable from a plurality of filters carried by a filter holder mechanism 39 accommodated in the seat 38 (for example, in which the filters are carried by a carousel rotating about the optical axis C or by a slider shifting orthogonally to the optical axis C).

It is clear that microscope 1 may be provided with various combinations of LEDs 15; in all cases, the possibility of replacing at least one of the modules 13 further increases the versatility of the microscope 1. A basic configuration of the microscope 1 envisages for example a white light LED 15, arranged for example in the module 13b, and two coloured light LEDs 15, for example a blue light and a green light, arranged respectively in modules 13a and 13c.

When the white light LED is used, a mirror foil 30b (not necessarily a dichroic foil) is arranged in the chamber 17; when coloured light LEDs are used instead, a dichroic foil 30a is arranged in the chamber 17; the dichroic foil 30a also allows the simultaneous use of the two coloured light LEDs, if required.

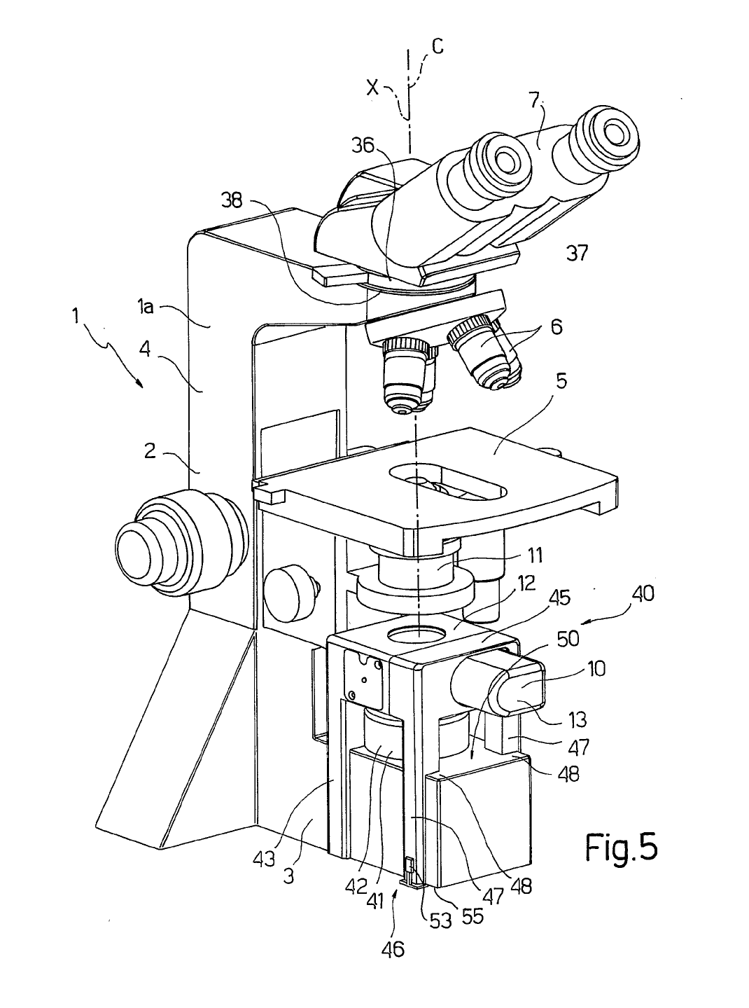

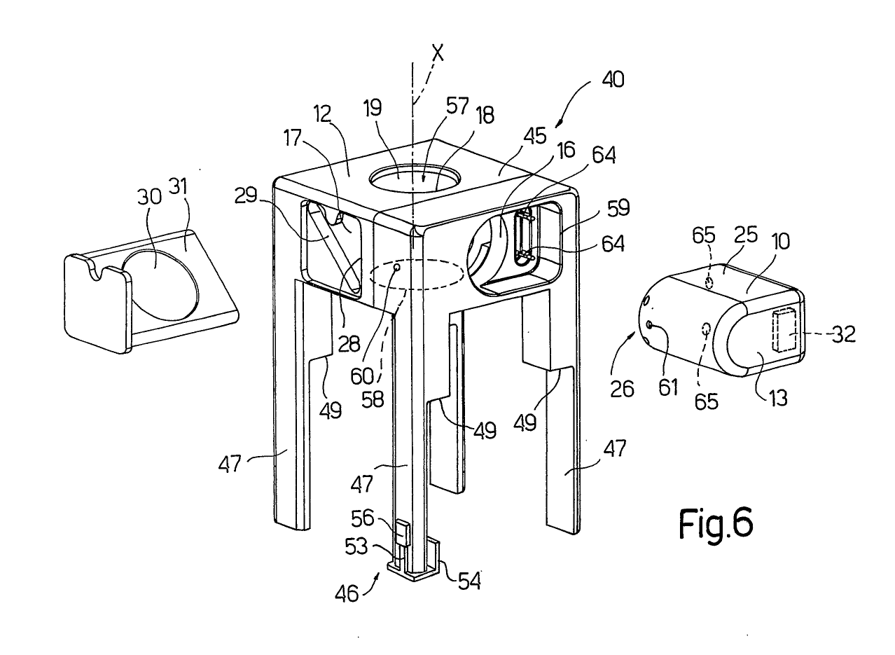

With reference to FIGS. 5 and 6, in which details similar or equal to those already described are indicated with the same numbers, a transmitted light fluorescence microscope 1 consists of a traditional white light microscope 1a and a transmitted light fluorescence working mode adaptation kit 40; the microscope 1a is any known microscope found on the market and has the same basic structure 2 already described; the microscope 1a also comprises an optical/lighting assembly 41 of the known type, accommodated in a body 42 fitted on the base 3, and provided with a traditional lamp (for example a halogen lamp) and the respective optics (known and not shown).

The adaptation kit 40 comprises a supporting unit 45, which carries a lighting assembly 10 with at least one integrated LED lighting module 13 and is insertable between the base 3 and the mount 5 of the microscope for lighting the mount 5 from underneath, releasable coupling means 46 of the unit 45 to the structure 2 of the microscope, a condenser 11, and a filter assembly 36.

The unit 45 presents a box 12 and the coupling means 46 comprise supporting elements 47 which protrude from the box 12 cooperating with respective portions 48 of the structure 2; in the non-limiting example shown in FIGS. 5 and 6, the elements 47 are formed by respective legs which protrude vertically from the box 12 and are provided with shoulders 49 which rest on a locator surface 50 of the base 3; the box 12 possibly presents a lower centering portion (not shown) which cooperates with the body 42, for example a peripheral upper end edge of the body 42, to provide a reference for the assembly of the unit 45 on the microscope 1a.

The coupling means 46 also comprise fastening members 53 of any known type (only one of which is shown, only schematically, in FIGS. 5 and 6 for the sake of simplicity), fixed to the box 12 or to the elements 47 and releasably fastened to the base 3 to integrally fasten the unit 45 to the structure 2; in the non-limiting example shown in FIG. 6, the fastening members 53 comprise hooks 54 which hook onto a lower edge 55 of the base 3 on opposite sides of the base 3, and respective lever latches 56 which integrally connect the latches 54 to the elements 47; it is however understood that fastening members of any other known type may be equally used, for example elastic clips, tie-rods or straps.

The box 12 presents a inner chamber 17 having an exit window 18, arranged in use in front of the condenser 11 and closed by a transparent plate 19; the chamber 17 comprises an inner through cavity 57, which extends along an axis X and is arranged through the box 12 between the window 18 and a lower window 58, aligned with the window 18; in use, when the unit 45 is fitted on the microscope 1a, axis X essentially coincides with optical axis C of the condenser 11 and with the optical axis of the assembly 41 and the cavity 57 allows the light emitted by the assembly 41 to cross the unit 45, allowing therefore the use of the assembly 41, also with unit 45 fitted on the microscope 1a. The chamber 17 also presents in this case a side opening 28 associated with a guide 29, formed in the chamber 17 and slanted with respect to axis X, and through which a reflecting foil 30 fitted on a slider 31 sliding on the guide 29 may be inserted and extracted. Different foils 30 (mirrors or possibly dichroic foils) are selectively usable in the chamber 17 according to the module 13 (and therefore of the LED 15) fitted on the unit 45.

The box 12 then presents at least one seat 16 for a LED module 13 of the type already described above (and therefore comprising again a casing 25 in which are accommodated a LED 15, a collimator 20 and a filter 21, not shown in FIGS. 5 and 6 for the sake of simplicity, being however entirely similar to those shown in FIGS. 1 and 2).

The seat 16 is delimited by a peripheral edge 59 in which is insertable the casing 25 of the module 13 and is communicating with the chamber 17 so that the module 13 is facing, once fitted in the seat 16, the foil 30 in the chamber 17.

The casing 25 is provided with releasably fastening means 26 to the seat 16; as already described with reference to FIGS. 1 and 2, also in this case the means 26 can be of any known type and have the function of allowing the complete removal of the module 13 from the box 12 and its replacement with another similar module having a LED with a different emission band. In the example of FIGS. 5 and 6, the fastening of the casing 25 in the seat 16 is obtained by means of a threaded dowel 60 arranged through the casing 12 and engaging a notch 61 formed on an outer surface of the casing 25.

The seat 16 presents a pair of facing spring contacts 64, cooperating with respective terminals 65 of the module 13 to ensure electrical powering and electronic management of the module 13; for the sake of simplicity, the electrical connections between the contacts 64 and the power source (external mains or battery) are not shown.

The condenser 11 that is part of the adaptation kit 40 has already been described above and it is used to replace the standard condenser of the microscope 1 by using the same fastening system of the standard condenser.

The filter assembly 36 comprises one or more emission filters 37 to be used in combination with the modules 13 (and selected according to the LED used); as already shown with reference to FIG. 1, the filter assembly 36 is inserted in a seat 38 (which is normally prearranged on traditional microscopes upstream of the eyepiece 7).

The adaptation kit 40 makes microscope 1a suitable for transmitted light fluorescence analysis, without requiring any structural modification or other type of intervention on the microscope except for the replacements of components which are already prearranged to be interchangeable, such as the Abbe condenser and the filters arranged upstream of the eyepiece; the user may therefore fit the adaptation kit on a commonly marketed microscope without at all altering the functional components and electrical connections of the microscope.

According to an important aspect of the invention, the lighting assembly 10 included in the microscope 1 or belonging to the adaptation kit 40 comprises a module 13 provided with a LED-UV which emits in the ultraviolet; the collimator 20 associated to the LED-UV is in this case made of a low UV absorbance material, essentially not fluorescent by effect of UV radiation, for example glass or polymeric material with low or no fluorescent emission. Also the lenses 34 of the condenser 11 are made of a low UV absorbance material, essentially not fluorescent by effect of UV radiation, particularly of glass.

In a preferred configuration, shown schematically in FIG. 7, the module 13 with LED-UV is always of the type described above and thus comprises a casing 25 in which are housed a LED-UV 15 (which emits in the ultraviolet), a collimator 20 and a filter 21; the collimator 20 associated to the LED-UV 15 consists of a condenser 70 of the Abbe type, essentially equal to the condenser 11 but used upside-down with respect to the condenser 11, and that is with the LED-UV 15 arranged in the frontal focus of the condenser 70; the system constituted by two counterpoised condensers 20, 70 of the Abbe type forms a high numeric aperture optical system but above all a so-called “fully symmetric” system in the optical design theory, where most of the optical aberrations and mainly astigmatism and field curvature are reduced or fully eliminated, with consequent increase of excitation efficiency.

It is then clear that further changes and variations can be made to the microscope described and shown herein without departing from the scope of protection of the annexed claims.

In particular, according to a further variation, the lighting assembly 10 comprises a single “multichip” LED capable of selectively emitting in different bands of emission, instead of a plurality of LEDs 15 having respective different emission bands; the band of emission to be sent to the sample 8 to be analysed is selected by means of unit 32. The lighting assembly 10 comprises in this case a filter holder device (for example rotating carousel-type or shifting slider-type) for selectively carrying an appropriate filter in axis with the LED according to the selected emission band.

1. A transmitted light fluorescence microscope (1), comprising a sample-holder mount (5), a lighting assembly (10) and a condenser (11) interposed between the lighting assembly (10) and the mount (5); the microscope being characterised in that the lighting assembly (10) comprises at least one LED (15) which emits in a spectral band adapted to excite the fluorescence of the sample (8) to be analysed and is arranged below the mount (5) to light the sample (8) from underneath; and in that at least one emission filter (37) is interposed between the sample-holder mount (5) and an eyepiece (7) of the microscope for filtering the fluorescent emission of the sample (8).

2. A microscope according to claim 1, characterised in that the condenser (11) has a focal distance less than approximately 20 mm and preferably less than approximately 15 mm.

3. A microscope according to claim 1, characterised in that the condenser (11) has a numeric aperture higher than approximately 0.8 and preferably higher than approximately 0.9.

4. A microscope according to claim 1, characterised in that the lighting assembly (10) comprises a plurality of LEDs (15) having respective different emission bands, or a “multichip” LED having a plurality of different emission bands, and selector means (32) for selecting an emission band to be sent to the sample (8) to be analysed.

5. A microscope according to claim 1, characterised in that the emission filter (37) is interchangeable with another emission filter, or is selectable between a plurality of emission filters, according to the LED emission (15) used in the lighting assembly (10).

6. A microscope according to claim 1, characterised in that the LED (15) is associated to a collimator (20) and to a filter (21) arranged along an optical axis (A) of the collimator (20), the filter (21) being inclined with respect to the optical axis (A) of the collimator (20), preferably by an angle from approximately 10° to approximately 15°.

7. A microscope according to claim 1, characterised by comprising at least one integrated lighting module (13) interchangeable with another module having a LED (15) with a different emission band.

8. A microscope according to claim 1, characterised in that said interchangeable module (13) comprises a casing (25), inside which are accommodated a LED (15), a collimator (20) and a filter (21), and which is provided with releasable fastening means (26) to a seat (16).

9. A microscope according to claim 1, characterised by comprising a plurality of integrated lighting modules (13) provided with respective LEDs (15) having different emission bands.

10. A microscope according to claim 9, characterised by comprising three modules (13) arranged essentially as a T.

11. A microscope according to claim 9, characterised by comprising one or more dichroic or mirror foils (30) removably arranged between the modules (13) and the mount (5).

12. A microscope according to one of the preceding claim 1, characterised in that the lighting assembly (10) comprises a LED-UV (15) which emits in the ultraviolet.

13. A microscope according to claim 12, characterised in that the condenser (11) presents lenses (34) which are made of a low UV absorbance material, essentially not fluorescent by effect of UV radiation, in particular of glass.

14. A microscope according to claim 12, characterised in that the LED-UV (15) is associated to a collimator (20, 70) made of a low IJV absorbance material, essentially not fluorescent by effect of UV radiation, in particular of glass.

15. A microscope according to claim 12, characterised in that the LED-UV (15) is associated to a symmetric optical system formed by two opposed condensers (70, 11) of the Abbe type.

16. A kit (40) for adapting a microscope to the transmitted light fluorescent working mode, characterised by comprising a supporting unit (45), which carries a lighting assembly (10) with at least one integrated lighting module (13) having a LED which emits in a spectral band adapted to excite the fluorescence of a sample, and releasable coupling means (46) of the unit (45) to a base (3) of the microscope, the unit (45) being insertable between the base and a sample holder device (5) of the microscope for lighting said mount (5) from underneath; the kit also comprising at least one emission filter (37) insertable between the sample-holder mount (5) and an eyepiece (7) of the microscope for filtering the fluorescence emission of the sample (8).

17. An adaptation kit according to claim 16, characterised by comprising a condenser (11) fittable on the microscope and having a focal distance less than approximately 20 mm and preferably less than approximately 15 mm and a numeric aperture higher than approximately 0.8 and preferably higher than approximately 0.9.

18. An adaptation kit according to claim 16, characterised in that the lighting assembly (10) comprises a plurality of LEDs (15) having respective different emission bands, or a “multichip” LED having a plurality of different emission bands, and selector means (32) for selecting an emission band to be sent to the sample (8) to be analysed.

19. An adaptation kit according to claim 16, characterised in that the LED (15) is associated to a collimator (20) and to a filter (21) arranged along an optical axis (A) of the collimator (20), the filter (21) being inclined with respect to the optical axis (A) of the collimator (20), preferably by an angle from approximately 10° to approximately 15°.

20. An adaptation kit according to claim 16, characterised in that it comprises a plurality of modules (13) interchangeable to one another and having respective LEDs with different emission bands.

21. An adaptation kit according to claim 15, characterised by further comprising a filter assembly (36) fittable on the microscope before an eyepiece (7) of the microscope and comprising one or more selectable emission filters (37).

22. An adaptation kit according to claim 16, characterised in that the lighting assembly (10) comprises a LED-UV (15) which emits in the ultraviolet.

23. An adaptation kit according to claim 1, characterised in that the LED-UV (15) is associated to a collimator (20, 70) and a condenser (11) which are made of a low UV absorbance material, essentially not fluorescent by effect of UV radiation, in particular of glass.

24. An adaptation kit according to claim 22, characterised in that the LED-UV (15) is associated to a symmetric optical system formed by two condensers (70, 11) of the counterpoised Abbe type.

25. An adaptation kit according to claim 16, characterised in that the coupling means (46) comprise supporting elements (47), which protrude from the unit (45) to cooperate with respective portions (48) of the base (3) of the microscope, and fastening members (53), fastened to the unit (45) and releasably fastened to the base (3).

26. An adaptation kit according to claim 16, characterised in that the unit (45) comprises a box (12) presenting an inner through cavity (57) which extends along an axis (X) and is arranged through the box (12) between two windows (18, 58) aligned to allow a light beam to cross the box (12) along the axis (X).

27. An adaptation kit according to claim 16, characterised in that the unit (45) comprises a box (12) with an inner chamber (17) having a side opening (28), through which a reflecting foil (30) fitted on a slider (31) sliding on a guide (29) formed in the chamber (17) can be inserted and extracted.

28. An adaptation kit according to claim 16, characterised in that the unit (45) presents a pair of facing spring contacts (64), cooperating with respective terminals (65) of the module (13) to ensure the electrical powering and electronic management of the module (13).
